(19) United States
(12) Patent Application Publication
(10) Pub. No.: US 2005/0266930 A1
(43) Pub. Date: Dec. 1, 2005

(54) Method for manufacturing a multiple material golf club head

(76) Inventors: Wayne H. Byrne, Murrieta, CA (US); Herbert Reyes, Laguna Niguel, CA (US)

Correspondence Address: MICHAEL A. CATANIA;CALLAWAY GOLF COMPANY, 2180 RUTHEFORD ROAD, CARLASBAD, CA, 92008-7382, US

(21) Appl. No.: 11/138,548

(22) Filed: May 25, 2005

Related U.S. Application Data
(60) Provisional application No. 60/575,670, filed on May 28, 2004.

(51) Int. Cl. A63B 53/04; B23K 31/00; B23K 26/20

(52) U.S. Cl. 473/324; 473/345; 473/409; 219/121.14; 228/136

(57) ABSTRACT

A method for manufacturing a golf club head having a major body and a minor body is disclosed herein. The major body is preferably composed of a metal material and has a striking plate section, a return section, a sole section, a ribbon section and a ledge section. The minor body is preferably composed of a non-metal material and has a crown section and a ribbon section. The minor body is preferably attached by a liquid adhesive to the ledge section of the major body.

### CROSS REFERENCES TO RELATED APPLICATIONS

The present application is a continuation-in-part application of U.S. Provisional Application No. 60/575,670, which was filed on May 28, 2004.

### STATEMENT REGARDING FEDERALLY SPONSORED RESEARCH OR DEVELOPMENT

Not Applicable

### BACKGROUND OF THE INVENTION

1. Field of the Invention

The present invention relates to a method for manufacturing a golf club head with a major body composed of a metal material, and a minor body composed of a lightweight material. More specifically, the present invention relates to a method for manufacturing a golf club head with a major body composed of a metal material for a more efficient transfer of energy to a golf ball at impact, and a non-metallic minor body to control the mass distribution.

2. Description of the Related Art

One of the first (if not the first) disclosures of a golf club head composed of a plurality of plies of a pre-preg material is Great Britain Patent Number 1201648, which was filed in 1967 on behalf of William Charles Carlton.

In 1984 U.S. Pat. No. 4,449,707 issued to Hayashi et al., for a Golf Club Head of Carbon Fiber Reinforced Plastic, based on a Japanese Patent Application originally filed in 1982. The Hayashi Patent discloses surrounding a core with a fiber reinforced fabric to create a golf club head with a proper center of gravity.

Another disclosure is U.S. Pat. No. 4,545,580 to Tomita et al., for a Wood-Type Golf Club Head, based on a Japanese Patent Application originally filed in 1983. The Tomita Patent discloses a durable golf club head having an outer shell composed of a fiber reinforced plastic material, a foam center core, and an intermediate shell formed of a thermoplastic resin material.

Yet another disclosure is U.S. Pat. No. 4,630,826 to Nishigaki et al., for Golf Club Head. The Nishigaki Patent discloses body composed of a carbon resin layer and a cast resin layer with a face insert block composed of a ceramic material.

Still another disclosure is U.S. Pat. No. 4,778,185 to Kurokawa, for Wood-Type Core-Shell Golf Club Heads, based on a Japanese Patent Application originally filed in 1984. The Kurokawa Patent discloses a golf club head composed of a foam core and a shell composed of a material fiber reinforced plastic having long and short fibers.

### BRIEF SUMMARY OF THE INVENTION

The present invention provides a method of manufacturing a golf club head having a metal major body and a lightweight minor body in order to provide the golf club head with a high moment of inertia and greater forgiveness.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a front view of the golf club.

FIG. 2 is a bottom view of the golf club head of FIG. 1.

FIG. 3 is rear side view of the golf club head of FIG. 1.

FIG. 4 is a toe side view of the golf club head of FIG. 1.

FIG. 5 is a top plan view of the golf club head of FIG. 1.

FIG. 6 is a heel side view of the golf club head of FIG. 1.

FIG. 7 is a top plan view of the golf club head.

FIG. 8 is a cross-sectional view taken generally along line 8-8 of FIG. 7.

FIG. 8A is an isolated view of circle A of FIG. 8.

FIG. 8B is an isolated view of circle B of FIG. 8.

FIG. 9 is an exploded view of the components of the golf club head.

FIG. 10 is a perspective view of the preform manufacturing apparatus.

FIG. 11 is a left side view of the preform apparatus.

FIG. 12 is a right side view of the preform apparatus.

FIG. 13 is a bottom plan view of the preform apparatus.

FIGS. 14-20 are schematic views of various plunger heads for the minor body.

FIG. 21 is a flow chart of a method for manufacturing the golf club head.

FIG. 22 is a flow chart of an alternative method for manufacturing the golf club head.

FIG. 23 is a flow chart of a method of manufacturing the minor body of the golf club head.

FIG. 24 is a flow chart of an alternative method for manufacturing the golf club head.

FIG. 25 is a flow chart of an alternative method for manufacturing the golf club head.

### DETAILED DESCRIPTION OF THE INVENTION

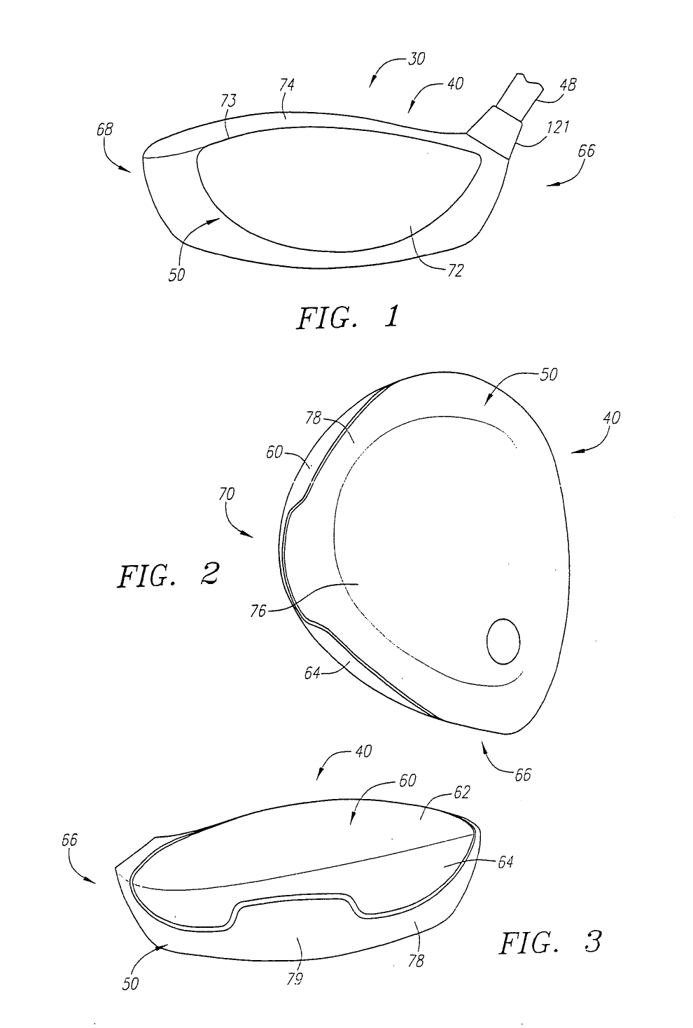

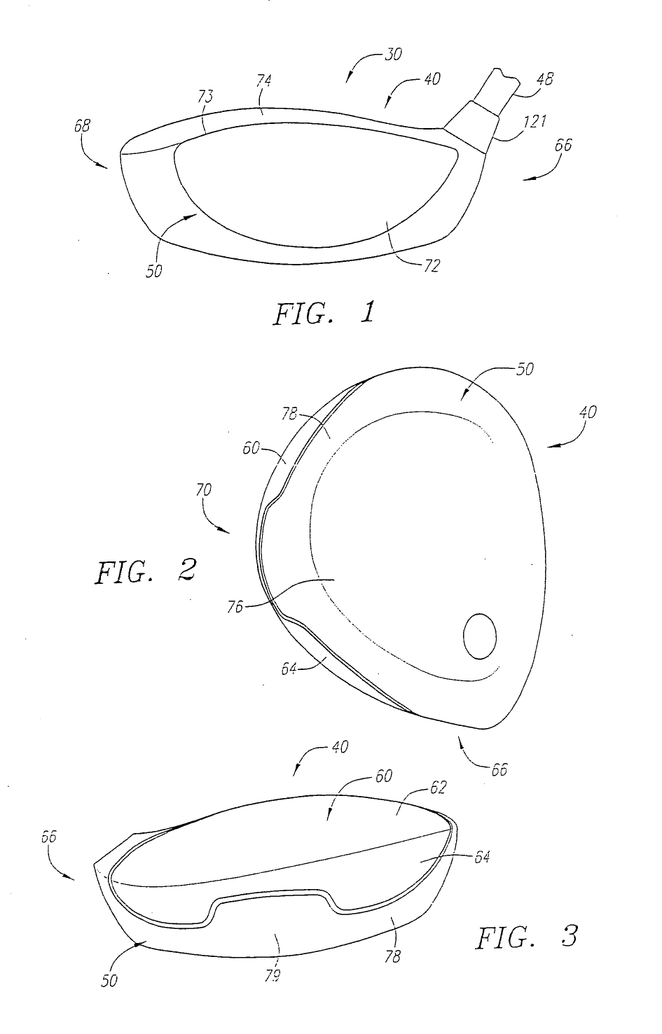

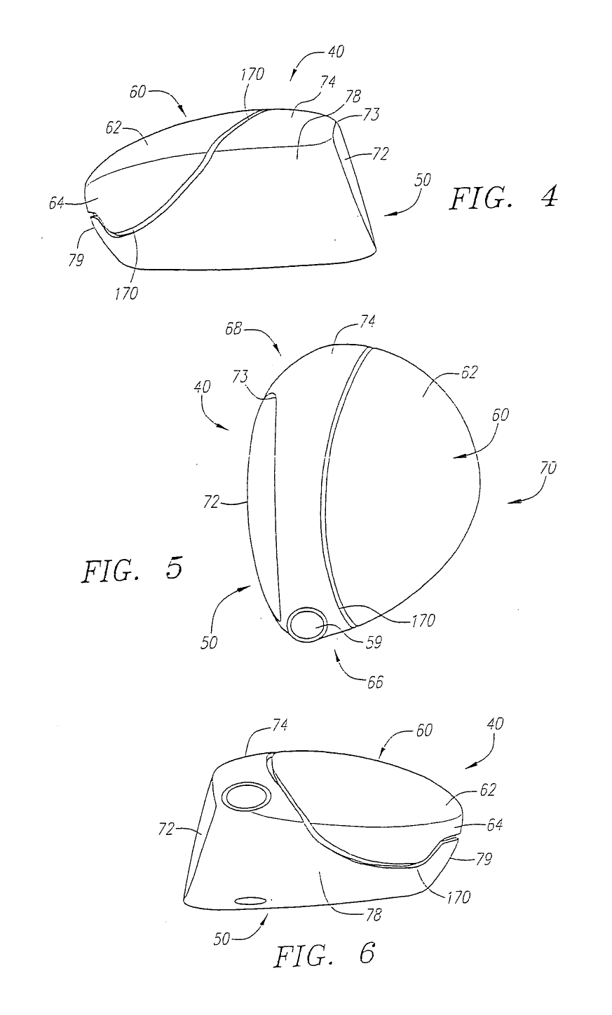

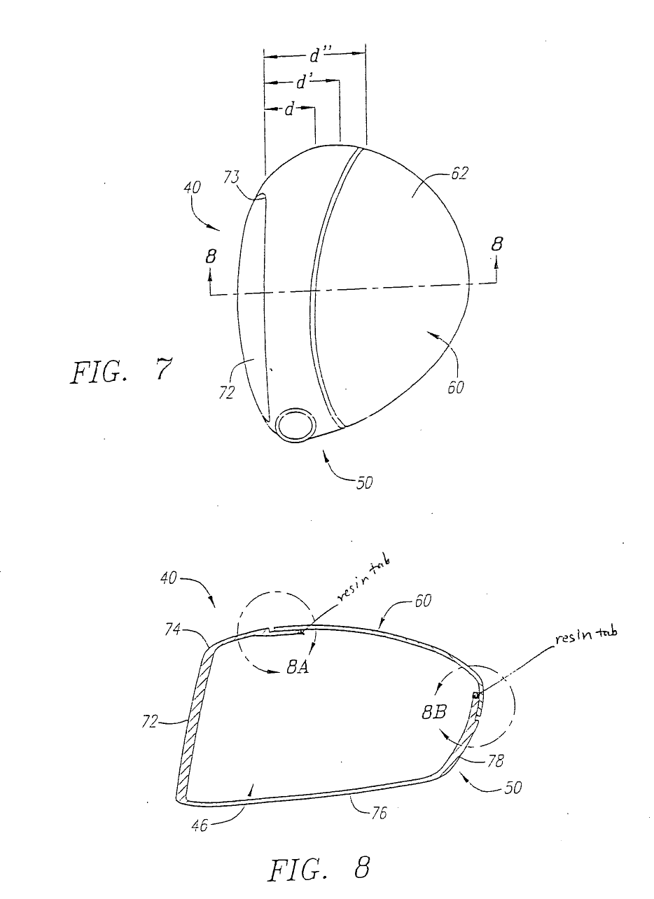

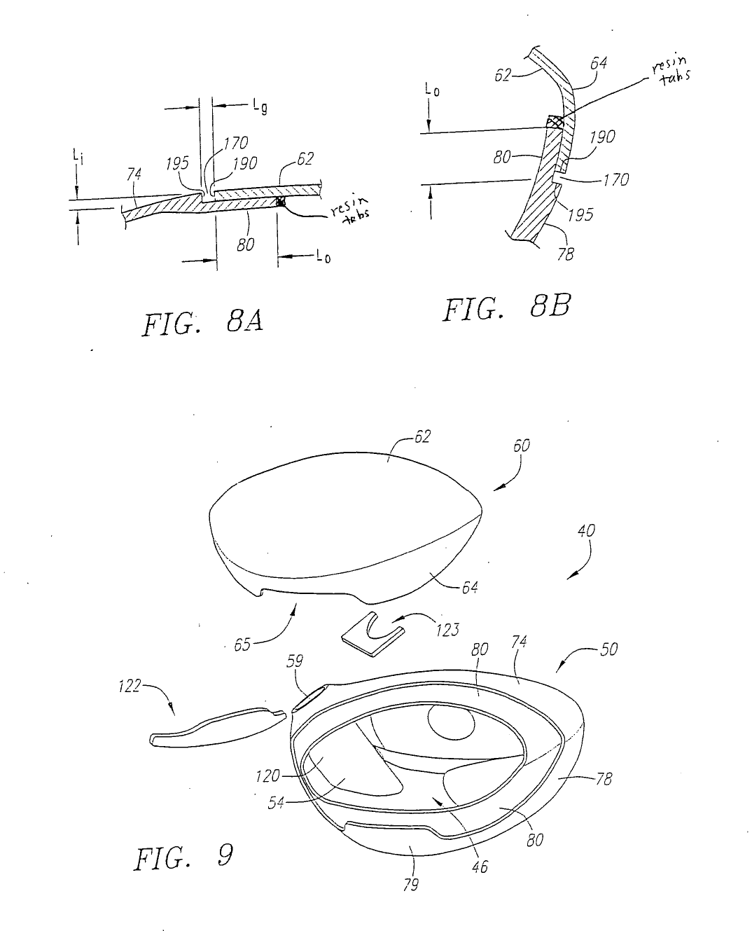

As shown in FIGS. 1-9, a golf club is generally designated 30. The golf club 30 has a club head 40 with a hollow interior 46. Engaging the club head 40 is a shaft 48 that has a grip, not shown, at a butt end and is inserted into a hosel 54 at a tip end.

The club head 40 is generally composed of two components, a major body 50 and a minor body 60. The minor body 60 has a crown section 62 and a ribbon section 64. The club head 40 may also be partitioned into a heel end 66 nearest the shaft 48, a toe end 68 opposite the heel section 66, and an aft end 70.

The major body 50 is generally composed of a single piece of metal, and is preferably composed of a cast metal material. More preferably, the cast metal material is a stainless steel material or a titanium material, such as pure titanium and titanium alloys, such as 6-4 titanium alloy, SP-700 titanium alloy (available from Nippon Steel of Tokyo, Japan), DAT 55G titanium alloy available from Diado Steel of Tokyo, Japan, Ti 10-2-3 Beta-C titanium alloy available from RTI International Metals of Ohio, and the like. Alternatively, the major body 50 may be manufactured through forging, welding, forming, machining, powdered metal forming, metal-injection-molding, electrochemical milling, and the like.

The major body 50 generally includes a striking plate section (also referred to herein as a face plate) 72, a return section 74 extending laterally rearward from the upper perimeter of the striking plate section 72, a sole section 76 extending laterally rearward from the striking plate section 72, a ribbon section 78 extending upward from the sole section 76, and a ledge section 80 stepped inward for attachment of the minor body 60. The striking plate section 72 typically has a plurality of scorelines thereon.

The return section 74 extends inward, towards the minor body 60, and has a general curvature from the heel end 66 to the toe end 68. The return section 74 has a length from the perimeter 73 of the striking plate section 72 that is preferably a minimal length near the center of the striking plate section 72, and increases toward the toe end 68 and the heel end 66. A distance d represents the length of the return section 74 from the perimeter 73 at the center of the striking plate section 72, a distance d′ from the perimeter 73 at the heel end 66 of the striking plate section 72, and a distance d″ from the perimeter 73 at the toe end 68 of the striking plate section 72. In a preferred embodiment, the distance d ranges from 0.2 inch to 1.0 inch, more preferably 0.30 inch to 0.75 inch, and most preferably 0.60 inch for a 3-wood golf club head 40 and 0.35 inch for an 11-wood golf club head 40, as measured from the perimeter 73 of the striking plate section 72 to the rearward edge of the return section 74. In a preferred embodiment, the distance d′ ranges from 0.4 inch to 1.25 inch, more preferably 0.50 inch to 0.100 inch, and most preferably 0.8 inch, as measured from the perimeter 73 of the striking plate section 72 to the rearward edge of the return section 74. In a preferred embodiment, the distance d″ ranges from 0.4 inch to 1.25 inch, more preferably 0.50 inch to 0.100 inch, and most preferably 0.9 inch, as measured from the perimeter 73 of the striking plate section 72 to the rearward edge of the return section 74. The perimeter 73 of the striking plate section 72 is defined as the transition point where the major body 50 transitions from a plane substantially parallel to the striking plate section 72 to a plane substantially perpendicular to the striking plate section 72. Alternatively, one method for determining the transition point is to take a plane parallel to the striking plate section 72 and a plane perpendicular to the striking plate section 72, and then take a plane at an angle of forty-five degrees to the parallel plane and the perpendicular plane. Where the forty-five degree plane contacts the major body 50 is the transition point, thereby defining the perimeter 73 of the striking plate section 72.

The minor body 60 is preferably composed of a non-metal material, preferably a composite material, such as continuous fiber pre-preg material (either thermosetting resin or thermoplastic resin). Other materials for the minor body 60 include other thermosetting materials or other thermoplastic materials such as injection molded plastics. The minor body 60 is preferably manufactured through bladder-molding, resin transfer molding, resin infusion, injection molding, compression molding, or a similar process. In a preferred process, the major body 50, with an adhesive on the exterior surface of the ledge section 80, is press-fitted with the minor body 60. Such adhesives include thermosetting adhesives in a liquid or a film medium. A preferred adhesive is a two part liquid epoxy sold by 3M of Minneapolis Minn. under the brand names DP420NS and DP460NS. Other alternative adhesives include modified acrylic liquid adhesives such as DP810NS, also sold by 3M. Alternatively, foam tapes such as Hysol Synspan may be utilized with the present invention.

As shown specifically in FIGS. 8A and 8B, the minor body 60 overlaps the ledge section 80 a distance Lo, which preferably ranges from 0.10 inch to 1.00 inch, more preferably ranges from 0.40 inch to 0.70 inch, and is most preferably 0.50 inch. The ledge section 80 is preferably spaced inward from the exterior surface of the major body 50 toward the hollow interior 46 a distance Li of 0.005 inch to 0.050 inch, more preferably 0.020 inch to 0.040 inch and most preferably 0.035 inch. The edge 195 of the major body 50 determines the inward distance Li of the ledge section 80. An annular gap 170 is created between an edge 190 of the minor body 60 and the edge 195 of the major body 50. The annular gap 170 has a distance Lg that preferably ranges from 0.020 inch to 0.100 inch, more preferably from 0.050 inch to 0.070 inch, and is most preferably 0.060 inch. An optional projection from an exterior surface of the ledge section 80 may establish a minimum bond thickness between the interior surface of the ledge section 80 and the overlapping portion of the minor body 60. The bond thickness preferably ranges from 0.002 inch to 0.100 inch, more preferably ranges from 0.005 inch to 0.040 inch, and is most preferably 0.0150 inch. A liquid adhesive preferably secures the minor body 60 to the ledge section 80 of the major body 50.

The crown section 62 of the minor body 60 is generally convex toward the sole section 76, and transitions into the ribbon section 64. The crown section 62 preferably has a thickness in the range of 0.010 to 0.100 inch, more preferably in the range of 0.025 inch to 0.070 inch, even more preferably in the range of 0.028 inch to 0.040 inch, and most preferably has a thickness of 0.033 inch. The ribbon section 64 preferably has a thickness in the range of 0.010 to 0.100 inch, more preferably in the range of 0.025 inch to 0.070 inch, even more preferably in the range of 0.028 inch to 0.040 inch, and most preferably has a thickness of 0.033 inch.

In a preferred embodiment, the minor body 60 is composed of a plurality of plies of pre-preg, typically six or seven plies, such as disclosed in U.S. Pat. No. 6,248,025, entitled Composite Golf Head And Method Of Manufacturing, which pertinent parts are hereby incorporated by reference in its entirety.

The sole section 76 of the major body 50 is generally convex toward the crown section 62. The sole section 76 alternatively has a recess for attachment of a sole plate thereto. The sole plate is preferably attached with a pressure sensitive adhesive such as a polyethylene foam acrylic adhesive sold by the 3M company. The sole plate is preferably composed of a lightweight metal such as aluminum, titanium or titanium alloy. Alternatively, the sole plate is composed of a durable plastic material. The sole plate may have graphics thereon for designation of the brand of club and loft.

FIG. 9 illustrates the hollow interior 46 of the club head 42. The hosel 54 is disposed within the hollow interior 46, and is preferably integral with the major body 50. The hosel 54 is preferably cast with the major body 50. Additionally, the hosel 54 may be composed of a non-similar material that is lightweight and secured using bonding or other mechanical securing techniques. A hollow interior of the hosel 54 is defined by a hosel wall 120 that forms a tapering tube from the aperture 59 to the sole section 78. The shaft 48 is disposed within a hosel insert 121 that in turn is disposed within the hosel 54. Such a hosel insert 121 and hosel 54 are described in U.S. Pat. No. 6,352,482, entitled Golf Club With Hosel Liner, which pertinent parts are hereby incorporated by reference.

As shown in FIG. 9, a rear weighting member 122 is preferably positioned within the hollow interior 46 of the club head 40. In a preferred embodiment, the rear weighting member 122 is disposed on the interior surface of the ribbon section 78 in order to increase the moment of inertia and control the center of gravity of the golf club head 40. A heel weighting member 123 is placed adjacent the hosel 54 on the interior surface of the sole section 76. However, those skilled in the pertinent art will recognize that additional weighting members may be placed in other locations of the club head 40 in order to influence the center of gravity, moment of inertia, or other inherent properties of the golf club head 40. The golf club head 40 preferably has a moment of inertia about the Izz axis through the center of gravity of the club head in the range of 1900 grams-centimeter squared to 5400 grams-centimeter squared. The weighting members 122 and 123 are preferably weight chip thickened areas of the major body 50 or weight chips welded to the interior surface of the major body 50. Those skilled in the pertinent art will recognize that other high density materials may be utilized as an optional weighting member without departing from the scope and spirit of the present invention.

Preferably, the major body 50 is cast from molten metal in a method such as the well-known lost-wax casting method. The metal for casting is preferably 17-4 stainless steel or titanium 6-4. Additional methods for manufacturing the major body 50 include forming the major body 50 from a flat sheet of metal, super-plastic forming the major body 50 from a flat sheet of metal, machining the major body 50 from a solid block of metal, electrochemical milling the major body 50 from a forged pre-form, and like manufacturing methods. Yet further methods include diffusion bonding titanium or steel sheets to yield a variable face thickness face and then superplastic forming.

The mass of the club head 40 of the present invention ranges from 165 grams to 250 grams, preferably ranges from 175 grams to 230 grams, and most preferably from 200 grams to 221 grams, with the three-wood golf club head 40 preferably having a mass of 203 grams and the eleven-wood golf club head 40 preferably having a mass of 221 grams. Preferably, the major body 50 has a mass ranging from 140 grams to 200 grams, more preferably ranging from 150 grams to 180 grams, yet more preferably from 155 grams to 166 grams, and most preferably 161 grams. The minor body 60 has a mass preferably ranging from 4 grams to 20 grams, more preferably from 5 grams to 15 grams, and most preferably 7 grams. The rear weighting member 122 has a mass preferably ranging from 10 grams to 50 grams, more preferably from 30 grams to 40 grams, and most preferably 31 grams. The heel weighting member 123 has a mass preferably ranging from 2 grams to 15 grams, more preferably from 3 grams to 10 grams, and most preferably 5 grams. Additionally, epoxy, or other like flowable materials, in an amount ranging from 0.5 grams to 5 grams, may be injected into the hollow interior 46 of the golf club head 40 for selective weighting thereof.

As previously stated, the preferred composite material is plies of carbon pre-peg sheets. The plies of pre-preg composite sheets are manufactured by pulling strands of fiber, preferably carbon, aramid or glass fiber, in a parallel motion through a resin film and allowing the resin to partially cure or “stage”. When the resin is partially staged, the resin holds the fibers together such that the fibers form a malleable sheet with all of the fibers in a specific orientation relative to an edge of the sheet. Preferred orientations are zero degrees, plus forty-five degrees, minus forty-five degrees and ninety degrees. Exemplary carbon pre-preg fiber sheets may be obtained from Newport Composites of Santa Ana, Calif., Fiberite Inc. of Greenville, Tex., or Hexcel Inc. of Pleasanton, Calif.

In creating the minor body 60, a first predetermined quantity of plies of pre-preg sheets is placed within a cavity configured to approximate the minor body. This first predetermined quantity of plies of pre-preg sheets for the minor body is compressed using a plunger or other similar device to create a stack of compressed plies. A second predetermined quantity of plies of pre-preg sheets for the minor body is placed within the cavity over the compressed plies. This second predetermined quantity of plies of pre-preg sheets for the minor body is then compressed using a plunger or other similar device to create a stack of more compressed plies. The process is repeated until a desired thickness of the minor body is achieved.

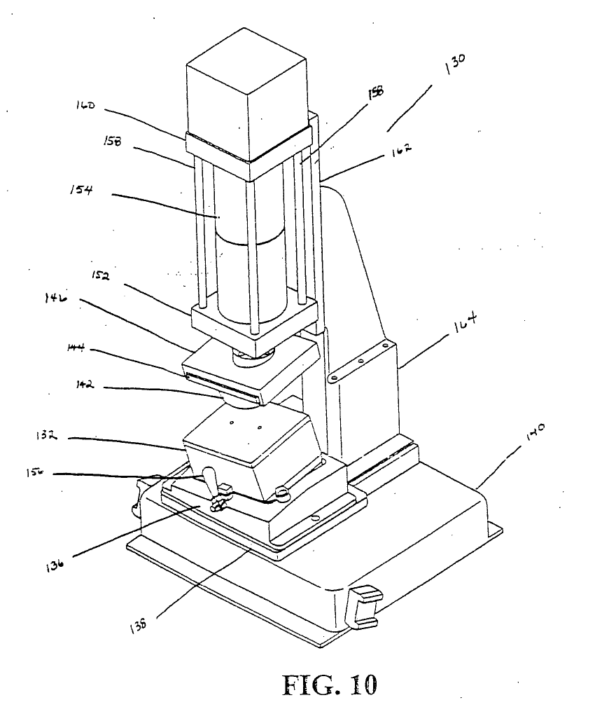

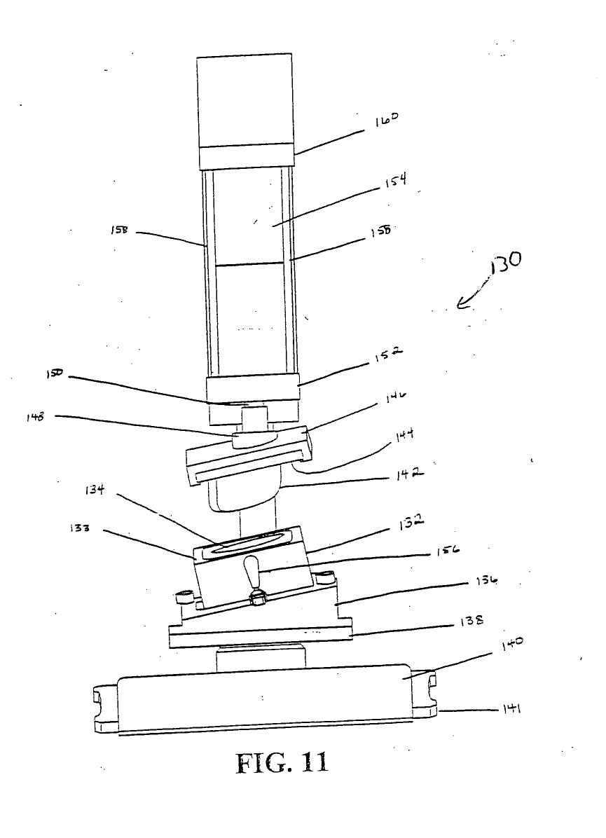

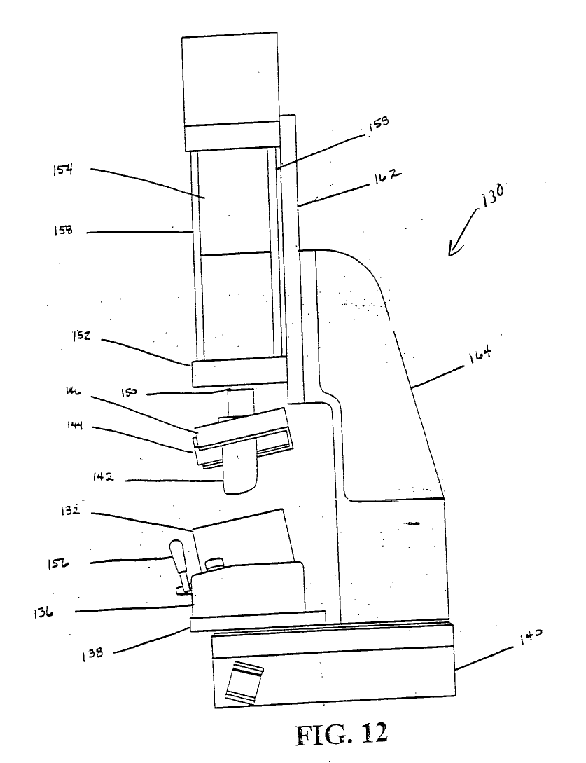

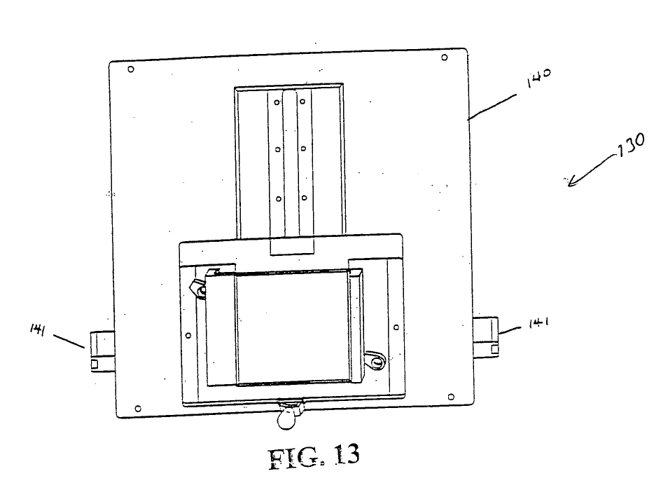

FIGS. 10-13 illustrate an apparatus 130 used in forming the preform for the minor body of a golf club head. The apparatus 130 comprises a mold 132 having an opening 133 in the top portion to define a cavity 134. The mold 132 is mounted to the apparatus 130 by a mold support plate 136. The mold support plate 136 is attached to the mold 132 at a top location and to a mold base plate 138 at a bottom location. The mold base plate 138 is held in place by attachment to a base 140 of the apparatus 130. The base 140 of the apparatus 130 may be free standing or may be mounted to a support structure using tabs 141 or other means of attachment.

The mold cavity 134 may be configured to approximate the minor body 60 by having an interior surface that conforms to the shape and volume of the minor body 60. A plunger head 142 is mounted on a removable plunger plate 144. The plunger head 142 is comprised of silicone, urethane or other elastomeric materials and preferably has a durometer ranging from 25 to 85 shore A and an elongation range of 100% to 700%. The plunger head 142 and removable plunger plate 144 are located above the cavity 134 and are used to compress the plies of pre-preg sheets into the cavity 134. The plunger head 142, which may be of various sizes to approximate the size of the cavity 134, is designed so that as the size of the plunger head 142 decreases, the corresponding volume of the preform that is created by using the plunger head 142 decreases. The removable plunger plate 144 allows for an assortment of plunger heads 142 to be interchanged to approximate the particular cavity size chosen for manufacturing a preform of the minor body 60.

The plunger head 142 is activated to press the plies into the cavity 134 to form the preform. Preferable pressure ranges for the plunger head 142 may range from 30-80 psi, however these ranges may be increased or decreased depending upon variations in the materials chosen to fabricate the preforms. The removable plunger plate 144 with the attached plunger head 142 is mounted to a fixed plate 146. The fixed plate 146 is subsequently attached via an attachment piece 148 to a moveable rod 150 located in a bottom portion of a lower support plate 152. The lower support plate 152 is used to support a pneumatic cylinder 154, thus aligning the pneumatic cylinder 154, plunger head 142, and cavity 134 along a longitudinal axis. The pneumatic cylinder 154 travels up and down in a vertical direction to allow oscillation of the plunger head 142 into and out of the cavity 134 along this longitudinal axis. A release lever 156 is located on the mold support plate 136 and is used to raise the plunger head 142 once the pre-preg plies have been compressed in the cavity 134. The pneumatic cylinder 154 is held in place by a series of support rods 158a-d in conjunction with the lower support plate 152 and an upper support plate 160. A mounting plate 162 is attached to a rear portion of the upper support plate 160 at one end and to the lower support plate 152 at an opposite end. A support arm 164 is used to align the mounting plate 162 in a vertical direction and is attached at one end to the mounting plate 162 and at an opposite end to the apparatus base 140.

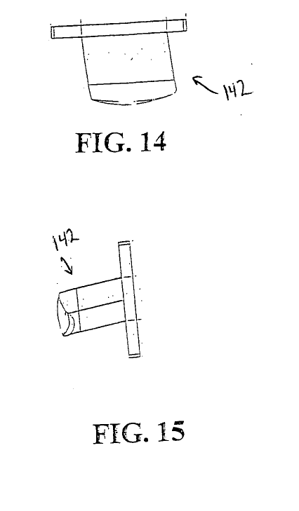

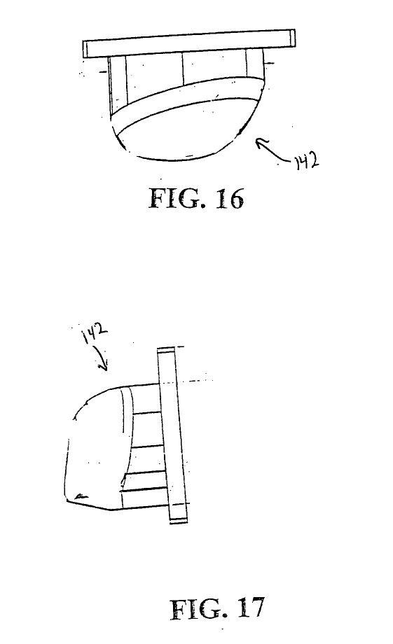

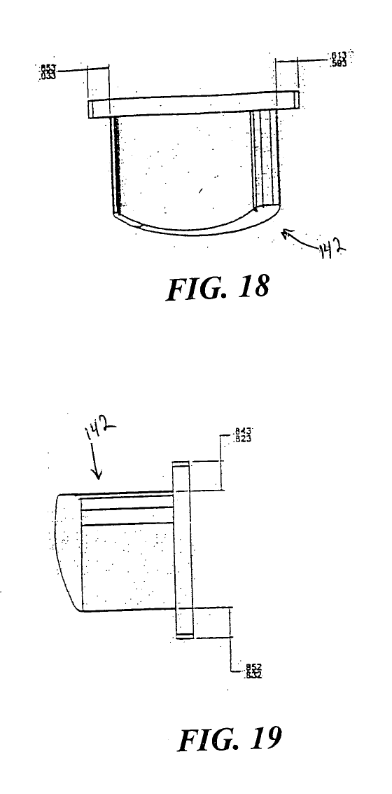

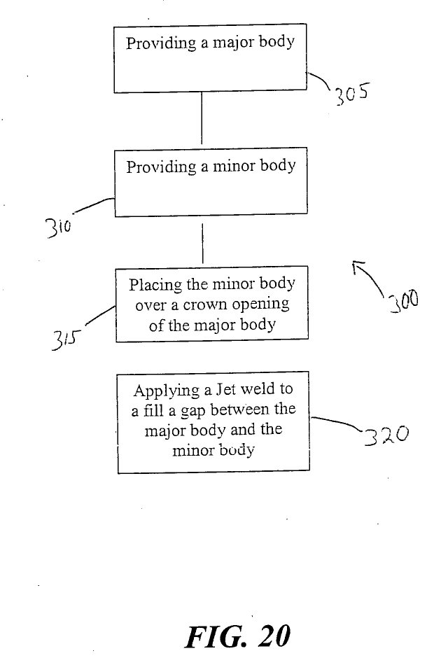

FIGS. 14-20 are schematic views of various plunger heads 142 for the minor body 60. A plunger head used in manufacturing a preform for the minor body 60 has a preferable volume range of 38 in³ to 45 in³, with a more preferable volume of 41 in³. It should be understood that these are only preferable ranges and that depending upon the size and volume of the club head desired the volumes of the plunger heads may be adjusted accordingly.

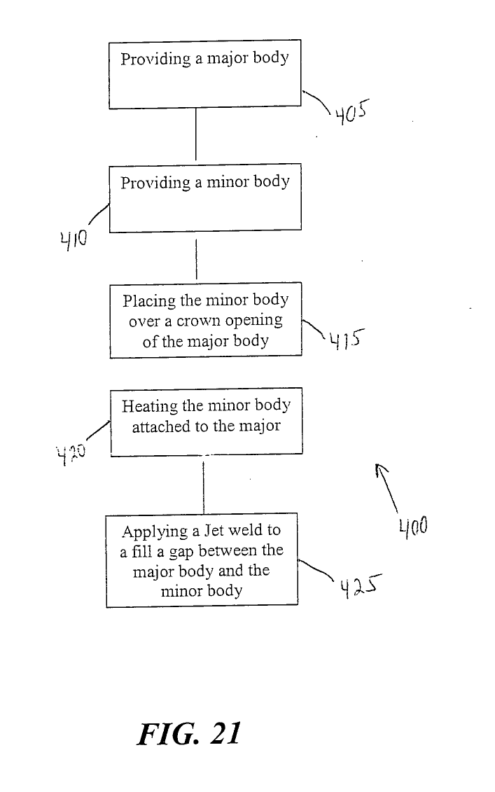

FIG. 21 is a flow chart of a preferred method 300 of manufacturing the golf club head 40 with the major body 50 and the minor body 60 as discussed above. At block 305, the major body 50 is provided. At block 310, the minor body 60 is provided. At block 315, the minor body 60 is placed over a crown opening of the major body 50 thereby providing a gap between the major body 50 and the minor body 60. At block 320, a JET WELD material is applied to the golf club head 40 to fill in the gap between the minor body 60 and the major body 50.

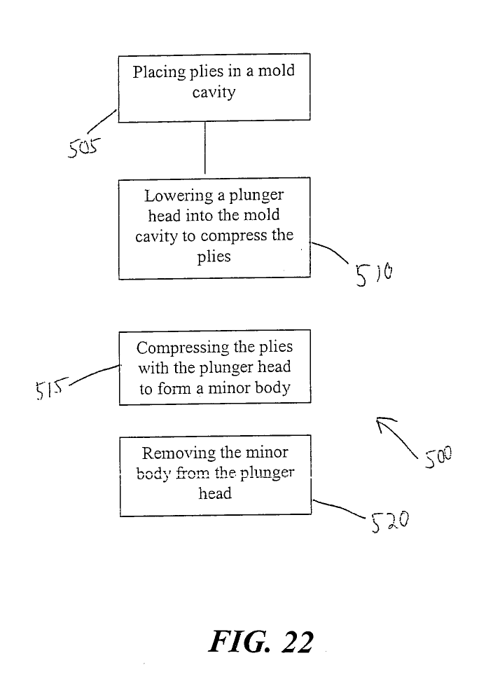

FIG. 22 is a flow chart of an alternative method 400 of manufacturing the golf club head 40 with the major body 50 and the minor body 60 as discussed above. At block 405, the major body 50 is provided. At block 410, the minor body 60 is provided. At block 415, the minor body 60 is placed over a crown opening of the major body 50 thereby providing a gap between the major body 50 and the minor body 60. At block 420, the minor body 60 is heated at a temperature ranging from 100° C. to 200° C. for a time period ranging from 10 minutes to 30 minutes. At block 425, a JET WELD material is applied to the golf club head 40 to fill in the gap between the minor body 60 and the major body 50.

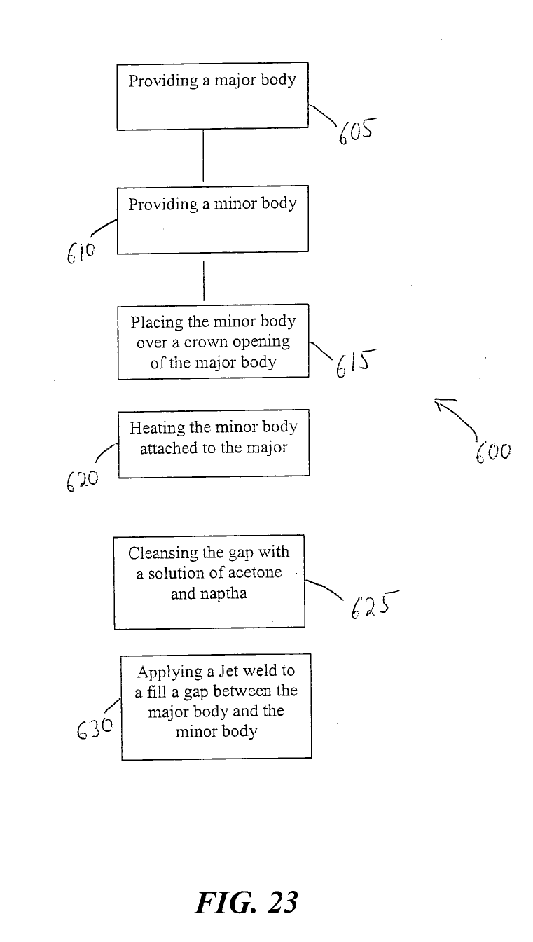

FIG. 23 is a method 500 for forming the minor body 60 of the golf club head 40. At block 505, a plurality of plies of pre-preg material are placed within a mold cavity of a forming apparatus as discussed above. At block 510, a plunger head, as described above, is lowered into the mold cavity. At block 515, the plies of pre-preg material are compressed to form the minor body 60. At block 520, the minor body 60 is removed from the mold cavity.

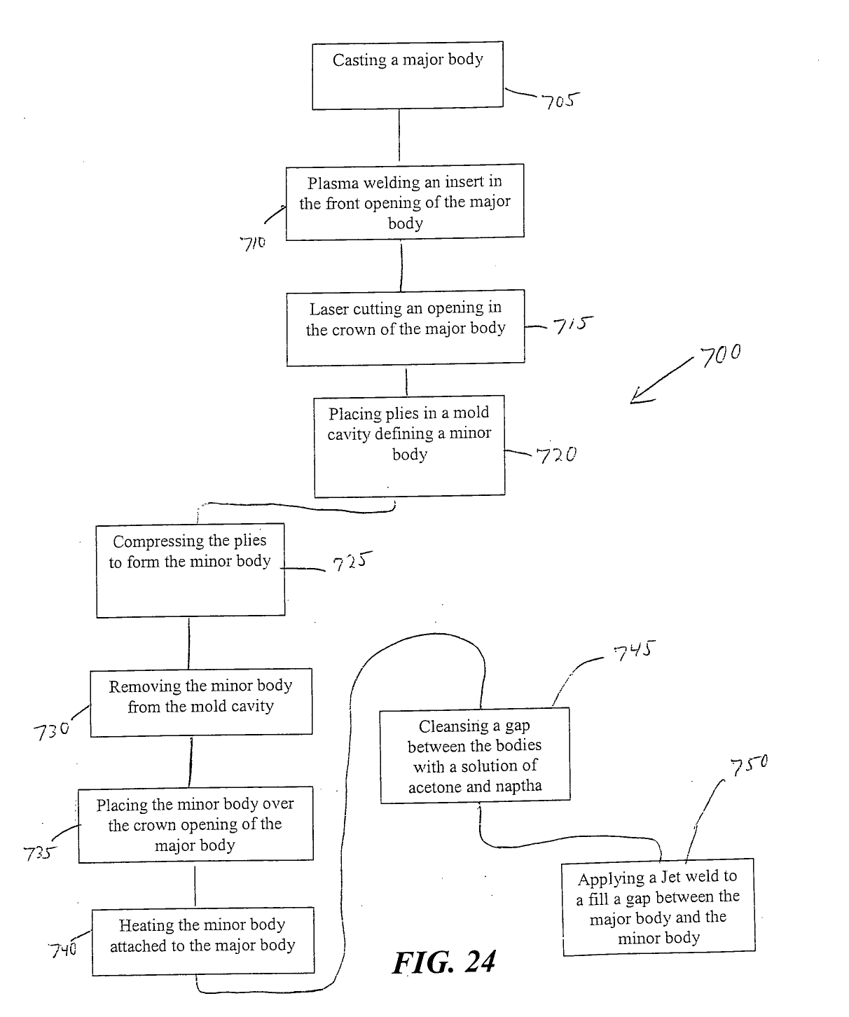

FIG. 24 is a flow chart of an alternative method 600 of manufacturing the golf club head 40 with the major body 50 and the minor body 60 as discussed above. At block 605, the major body 50 is provided. At block 610, the minor body 60 is provided. At block 615, the minor body 60 is placed over a crown opening of the major body 50 thereby providing a gap between the major body 50 and the minor body 60. At block 620, the minor body 60 is heated at a temperature ranging from 100° C. to 200° C. for a time period ranging from 10 minutes to 30 minutes. At block 625, the gap is cleaned with a solution of acetone and naptha. At block 630, a JET WELD material is applied to the golf club head 40 to fill in the gap between the minor body 60 and the major body 50.

FIG. 25 is a flow chart of a specific method 700 for manufacturing the golf club head 40 with the major body 50 and the minor body 60. At block 705, the major body 50 is cast is with an opening in the front wall. At block 710, a striking plate insert is plasma welded in the opening in the front wall of the major body 50. Typically, the striking plate insert is composed of a material that is an alloy variation of the material of the major body 50. At block 715, an opening is laser cut in the crown of the major body 50. At 720, a plurality of plies of pre-preg material are placed within a mold cavity of a forming apparatus as discussed above. At block 725, a plunger head, as described above, is lowered into the mold cavity to compress the plies of pre-preg material to form the minor body 60. At block 730, the minor body 60 is removed from the mold cavity. At block 735, the minor body 60 is placed over a crown opening of the major body 50 thereby providing a gap between the major body 50 and the minor body 60. At block 740, the minor body 60 is heated at a temperature ranging from 100° C. to 200° C. for a time period ranging from 10 minutes to 30 minutes. At block 745, the gap is cleaned with a solution of acetone and naptha. At block 750, a JET WELD material is applied to the golf club head 40 to fill in the gap between the minor body 60 and the major body 50.

In forming the minor body 60, the pre-pregs are preferably warmed from zero degrees Celsius to room temperature over a period of 24 hours. Next, the pre-pregs are cut to the appropriate length. Next, the pre-pregs are compacted using the plunger apparatus described above to create a minor body preform. Next, a liquid resin is injected into a male tool and the compacted minor body preform is placed within the tool. The liquid resin is of a different material than the minor body and the liquid resin eventually forms the resin tabs of the minor body. Next, the pre-form with tabs is placed in a compression tool and compressed. Next, the tool is chilled, and the minor body is removed and inspected.

In finishing the minor body, the minor body is first sand blasted. Next, the minor body is cleaned with butylacetate. The minor body is then sanded and cleaned again. Next, portions of the minor body are masked and any pin holes are filled. The minor body is then sanded and cleaned again with butylacetate. Next, a seal coat is applied to the minor body. The minor body then is sanded and cleaned again and inspected. Next, the minor body is painted with a clear or texture coating. The coated minor body is then cured at a temperature ranging from 150° C. to 250° C. for a time period ranging from 10 minutes to 30 minutes.

In attaching the minor body 60 to the major body 50, epoxy is preferably applied to the ledge section 80 of the major body 50. Next, the bonding surfaces of the major body 50 and the minor body 60 are wetted. Next, the major body 50 and the minor body 60 are placed in a fixture. Next, the minor body 60 and the major body 50 are cured at a temperature ranging from 100° C. to 200° C. for a time period ranging from 10 minutes to 30 minutes. Next, the assembled golf club head 40 is removed from the fixture. Next, a reveal gap of the golf club head is cleaned with a 50/50 solution of acetone and naptha. Next, a jetweld is applied in the reveal gap, preferably in a humidity controlled environment. Next, excess jetweld is removed. The golf club head 40 is then cleaned with the solution of acetone and naptha and finished.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

1. A method for manufacturing a golf club head, the method comprising:
providing a major body comprising a sole, a crown with an opening, and a front wall, the body composed of a metal material;
providing a minor body composed of a non-metal material;
placing the minor body over the crown opening wherein a gap is created between an edge of the crown and an edge of the minor body; and
applying a jet weld to fill the gap.

2. A method for manufacturing a golf club head, the method comprising:
providing a major body comprising a sole, a crown with an opening, and a front wall, the body composed of a metal material;
providing a minor body composed of a non-metal material;
placing the minor body over the crown opening wherein a gap is created between an edge of the crown and an edge of the minor body;
heating the minor body attached to the major body at a temperature ranging from 100° C. to 200° C. for a time period ranging from 10 minutes to 30 minutes; and
applying a jet weld to fill the gap.

3. A method for manufacturing a golf club head, the method comprising:
providing a major body comprising a sole, a crown with an opening, and a front wall, the body composed of a metal material;
providing a minor body composed of a non-metal, material;
placing the minor body over the crown opening wherein a gap is created between an edge of the crown and an edge of the minor body;
heating the minor body attached to the major body at a temperature ranging from 100° C. to 200° C. for a time period ranging from 10 minutes to 30 minutes;
cleansing the gap with a solution of acetone and naptha; and
applying a jet weld to fill the gap.

4. The method according to claim 1 wherein the major body further comprises a return section, a ribbon section and a ledge section, the return section extending a distance ranging 0.25 inch to 1.5 inches from a perimeter of the front wall.

5. The method according to claim 4 wherein the minor body comprises a crown section and a ribbon section, the minor body is attached to the ledge section of the major body, and the minor body has a mass ranging from 4 grams to 20 grams.

6. The golf club head according to claim 5 wherein the ledge section is spaced inward a distance ranging from 0.005 inch to 0.020 inch from an exterior surface of the major body.

7. The golf club head according to claim 1 wherein the golf club head has a volume ranging from 200 cubic centimeters to 500 cubic centimeters.

8. The golf club head according to claim 1 wherein the moment of inertia about the Izz axis through the center of gravity of the golf club head ranges from 1900 grams-centimeter squared to 5400 grams-centimeter squared.

9. A method for forming a preform for a minor body for a golf club head, the preform composed of plies of pre-preg sheets, the method comprising:
placing a plurality of plies of pre-preg sheets in a mold cavity, the mold cavity configured to define a preform for the minor body of the golf club head;
lowering a plunger head along a longitudinal axis toward the mold cavity, the plunger head configured to compress the plurality of plies of pre-preg sheets into the minor body of the golf club head;
compressing the plurality of plies of pre-preg sheets with the plunger head to form the minor body of the golf club head; and
removing the minor body of the golf club head from the mold cavity.

10. A method for manufacturing a golf club head, the method comprising:
casting a major body for the golf club head, the major body having a sole, a crown, and a front wall with an opening;
plasma welding a striking plate insert in an opening of the front wall of the major body;
laser cutting an opening in the crown of the major body;
placing a plurality of plies of pre-preg sheets in a mold cavity, the mold cavity configured to define a preform for a minor body of the golf club head;
lowering a plunger head along a longitudinal axis toward the mold cavity, the plunger head configured to compress the plurality of plies of pre-preg sheets into the minor body of the golf club head;
compressing the plurality of plies of pre-preg sheets with the plunger head to form the minor body of the golf club head;
removing the minor body from the mold cavity;
placing the minor body over the crown opening wherein a gap is created between an edge of the crown and an edge of the minor body;
heating the minor body attached to the major body at a temperature ranging from 100° C. to 200° C. for a time period ranging from 10 minutes to 30 minutes;
cleansing the gap with a solution of acetone and naptha; and
applying a jet weld to fill the gap.

11. A method for manufacturing a golf club head, the method comprising:
sand blasting a minor body of the golf club head, the minor body composed of a pre-preg material;
cleaning the minor body with butylacetate subsequent to sand blasting;
sanding the minor body subsequent to cleaning;
cleaning the minor body with butylacetate subsequent to sanding;
masking portions of the minor body;
filling pin holes of the minor body;
sanding the filled pin holes of the minor body;
cleaning the minor body with butylacetate subsequent to sanding the filled pin holes;
applying a seal coat to the minor body;
sanding the seal coat on the minor body;
cleaning the minor body with butylacetate subsequent to sanding the seal coat;
inspecting a plurality of pin holes of the minor body;
spray painting a clear or texture coating on the minor body; and
curing the painted minor body at a temperature ranging from 150° C. to 250° C. for a time period ranging from 10 minutes to 30 minutes.
